(19) United States
(12) Patent Application Publication
(10) Pub. No.: US 2003/0110120 A1
(43) Pub. Date: Jun. 12, 2003

(54) Method and system for displaying price charts

(76) Inventor: James D. Salehi, New York, NY (US)

Correspondence Address: ADENIKE A. ADEWUYA, 4606 FM 1960 WEST, SUITE 400, HOUSTON, TX, 77069, US

(21) Appl. No.: 10/191,051

(22) Filed: Jul. 8, 2002

Related U.S. Application Data
(60) Provisional application No. 60/341,057, filed on Dec. 6, 2001.
(60) Provisional application No. 60/374,865, filed on Apr. 23, 2002.

(51) Int. Cl. G06F 17/60

(52) U.S. Cl. 705/37

(57) ABSTRACT

Methods for displaying price charts are disclosed. One method includes loading into a memory a set of stored chart images representing a set of price charts, displaying a selected one of the stored chart images on a screen, and mapping between a set of pixel positions on the selected stored chart image and a set of charted points on the corresponding price chart. Another method includes specifying a timestamp sequence, iteratively selecting individual timestamps from the timestamp sequence, and, for each selected timestamp, rendering a price chart image on a screen such that a set of charted points indicated by the selected timestamp is displayed. Another method includes selectively displaying trade events on a rendered price chart image and, for each displayed trade event, showing a graphic notation at a point on the price chart corresponding to the time and price values of the trade event.

### CROSS-REFERENCE TO RELATED APPLICATIONS

This application claims priority from U.S. Provisional Application Serial No. 60/341,057, filed Dec. 6, 2001, and U.S. Provisional Application Serial No. 60/374,865, filed Apr. 23, 2002.

### FIELD OF THE INVENTION

The invention relates generally to financial securities trading systems. More specifically, the invention relates to a method and a system for visualizing prices of a security over a period of time.

### BACKGROUND ART

Price charts are useful in analyzing securities and forecasting price movements. The term “securities,” as used herein, refers to any asset that can be traded on the financial market, such as stocks, bonds, commodities, futures, or market indexes. A price chart displays a series of prices as a function of time. The price chart may also display volume of shares traded as a function of time as well as other information useful in analyzing trends and patterns in the market, including technical indicators such as moving averages, trading ranges, relative strength index, and momentum.

The timeframe of a price chart may be intra-day, daily, weekly, monthly, quarterly, or annual. An intra-day chart displays price data for one or more days in intervals of one or more minutes. For each interval, a single set of price data is displayed, e.g., the open, close, high and low prices for the interval. A daily chart displays a single set of price data for each day of trading. A weekly chart displays a single set of price data for each week of trading, and so forth. Short-term charts, e.g., intra-day and daily charts, are generally used to forecast short-term price movements, while long-term charts, e.g., weekly and monthly charts, are generally used to forecast long-term price movements.

Price charts are also useful in determining the effectiveness of a trading strategy. The term “trading strategy,” as used herein, refers to a set of rules that specifies precisely when a buy or sell action is to be taken. The rules may be based on price, volume, other technical indicator, or other factors. For example, at the end of a trading day, a trader or technical analyst may review a set of price charts to determine where buy or sell actions would have taken place had some specific trading strategy been implemented. The analyst may then compare these buy or sell actions to the actual buy or sell actions that occurred during the trading day.

While reviewing the price charts, the analyst may also identify other timepoints that do not necessarily correspond to buy or sell actions. The term “timepoint,” as used herein, refers to a time at which some event of particular interest occurs on the price chart, such as steep volume increase or completion of a notable technical pattern. At each of these timepoints, the analyst may make observations about the price chart and generate associated commentary. Ideally, the analyst would later be able to review the price charts to see how the price charts appeared at each timepoint, i.e., view the price charts with price data displayed up to, but not beyond, the indicated timepoint, along with the associated commentary. Ideally, the analyst would also be able to make observations about the effectiveness of a particular trading strategy while reviewing the price charts.

However, the charting and analysis applications in the current art do not provide a mechanism for reviewing price charts such that the state of the market at specific timepoints on these charts can be iteratively observed. Instead, the analyst usually has to resort to manual methods to review the charts in the manner stated above. Such manual methods generally involve generating hardcopies of the price charts and manually blocking the portions of the charts that should not be visible at each timepoint.

Further, the charting and analysis applications in the current art do not provide the capability to display price charts derived from stored chart images, yet relying on stored chart images to observe a prior state of the market has certain advantages. One advantage is that price charts derived from stored chart images can be the exact charts used by the trader on a given day, i.e., when the stored chart images reflect the screen images displayed by the charting application used by the trader on that day, even months or years later. Another advantage is that stored chart images can be easily obtained, e.g., using a program that captures screen images and saves the captured image to a file on disk. The alternative to using stored chart images is to build the price charts dynamically from price data. However, in practice, access to a price data source can be cumbersome to obtain, typically necessitates a fee to the data source provider, and may not be permanently accessible.

Therefore, what is desired is a tool for reviewing a set of price charts, possibly derived from stored chart images, while giving the user an opportunity to observe the state of the market at specific timepoints on the charts.

### BRIEF SUMMARY OF THE INVENTION

In one aspect, the invention relates to a method of displaying price charts which comprises loading into a memory a set of stored chart images representing a set of price charts, displaying a selected one of the stored chart images on a screen, and mapping between a set of pixel positions on the selected stored chart image and a set of charted points on the corresponding price chart. In one embodiment, the method further includes specifying a timestamp and modifying the display of the selected stored chart image such that only a portion of the selected stored chart image indicated by the timestamp is visible on the screen.

In another aspect, the invention relates to a method of displaying price charts which comprises rendering a price chart image on a screen, specifying a set of trade events, each trade event having a time value, a price value, and an action property, and selectively displaying the trade events on the rendered price chart. For each displayed trade event, the rendering of the price chart image is modified such that a graphic notation is shown at a point on the price chart corresponding to the time and price values of the trade event.

In yet another aspect, the invention relates to a method of specifying a sequence of timestamps, iteratively selecting individual timestamps from the sequence of timestamps, and rendering a price chart image on a screen, for each selected timestamp, such that a set of charted points indicated by the selected timestamp is displayed.

In another aspect, the invention relates to a method of displaying price charts which comprises rendering a price chart on a screen such that in response to input instructions a specified portion of the rendered price chart is rotated by a specified degree about a specified axis.

Other aspects and advantages of the invention will be apparent from the following description and the appended claims.

### BRIEF DESCRIPTION OF THE DRAWINGS

FIG. 1 is a layout of a computer system suitable for practicing the invention.

FIG. 2 is a block diagram of a system for displaying a set of price charts according to one embodiment of the invention.

FIG. 3 is one implementation of an interface panel for user interaction with the system of the invention.

FIG. 4 shows a file dialog window invoked from the interface panel of FIG. 3.

FIG. 5 shows the interface panel of FIG. 3 after chart images have been defined in the system and one of the chart images is rendered in the graphics area of the interface panel.

FIG. 6 shows reference locators displayed on a chart image shown in the interface panel of FIG. 3.

FIG. 7 shows the visual effect of partial-chart display, under which a chart image is displayed only up to an indicated charted time value or horizontal image location.

FIG. 8 shows trade events displayed on a chart image shown in the interface panel of FIG. 3.

FIG. 9 illustrates the use of a dialog window to modify trade event properties.

FIG. 10 illustrates a method of specifying an animation timestamp for the chart image shown in the interface panel of FIG. 3.

FIG. 11 shows a group of animation timestamps displayed in a text area of the interface panel of FIG. 3.

FIG. 12 shows a method of animating the presentation of a chart image, displayed in the interface panel of FIG. 3, based on timestamp value.

FIGS. 13A-13F show a chart image, displayed in the interface panel of FIG. 3, at different points during an animated presentation.

FIG. 14 shows the rotation of a chart image displayed in the interface panel of FIG. 3.

### DETAILED DESCRIPTION OF THE INVENTION

Embodiments of the invention provide a method and a system for creating and displaying an interactive presentation of a set of price charts, possibly according to a set of specified timepoints. As previously mentioned, the term “timepoint” refers to a time at which some event of interest occurs on the price chart. The system allows the user to visually examine the price charts and to quantitatively evaluate the performance of a specific trading strategy on the price charts. The term “chart image,” as used herein, refers to the system representation of a price chart, i.e., representation of the price chart within the system. The chart images could be derived from stored chart images or price data. The user may use the information gleaned from review of the price charts to determine, for example, the effectiveness of a specific trading strategy.

The term “stored chart image,” as used herein, refers to a file containing an image of a price chart. The price chart is generated by a charting application, such as RealTick® from Townsend Analytics, Ltd. There are also many freely-available charting applications on the World-Wide-Web. The image of the price chart is written to the file in some published graphic format, such as Windows® bitmap (.bmp), graphics interchange format (.gif), joint pictures expert group (.jpeg), or portable network graphics (.png). The file may be created directly by the charting application, e.g., via an “Export” command, or by a third-party program that captures the screen image of the price chart and stores the image to a file. The specific details of the process by which the file is created and stored on a storage medium are not important to understanding the principles of the invention.

Typically, the stored chart image displays two orthogonal marked axes, with time on one axis, usually the horizontal axis, and price on the other axis, usually the vertical axis. The stored chart image may also contain additional information, such as volume or technical indicators.

Specific embodiments of the invention will now be described with reference to the accompanying drawings.

A. System Overview

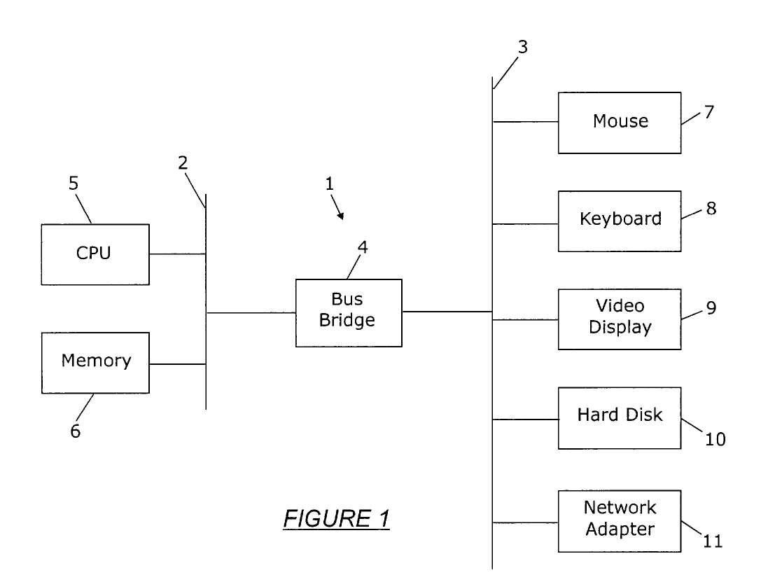

FIG. 1 shows a layout of a computer system 1 that is suitable for practicing the invention. In general, any computer system, whether standard or specialized, can be used in the invention. The computer system 1 includes a system bus 2 coupled to an input/output (I/O) bus 3 by a bus bridge 4. The main function of the bus bridge 4 is to move data between the system bus 2 and the I/O bus 3. A central processing unit (CPU) 5 and a memory 6 are attached to the system bus 2. A number of I/O devices, such as mouse 7 (or other pointing device), keyboard 8, video display 9, hard disk 10 (or other storage media), and network adapter 11, are connected to the I/O bus 3. The functions of the I/O devices 7, 8, 9, and 10 are well known. The network adapter 11 allows the computer system 1 to interface with other computer systems (not shown) through a network (not shown), such as a local area network (LAN), the World Wide Web (WWW), etc.

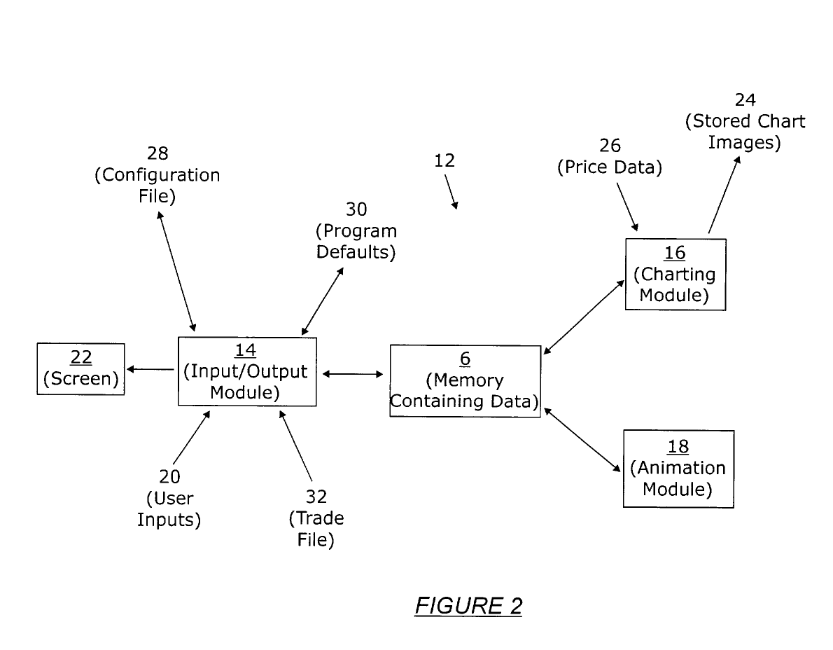

FIG. 2 shows a block diagram of a system, generally indicated at 12, for creating and displaying an interactive presentation of a set of price charts according to an embodiment of the invention. The system 12 includes an input/output module 14, a charting module 16, and an animation module 18. The input/output module 14, the charting module 16, and the animation module 18 are made of programs, which are executable by a processor, such as CPU (5 in FIG. 1). While operating the system 12, some or all of the programs may be loaded into memory 6 (also shown in FIG. 1). Additional data and programs needed to run the system 12 may be selectively loaded into memory 6 from a storage medium (not shown), such as hard disk (10 in FIG. 1), or from some other networked computer system.

The input/output module 14 allows a user to interact with the system 12. The input/output module 14 collects user inputs 20 and stores the user inputs 20 for later use by the charting module 16 and animation module 18. The charting module 16 loads price information into the system 12 and creates chart images in memory 6. The input/output module 14 renders the chart images on a screen 22. The animation module 18 controls manipulation of the chart images, including interactive presentation according to a set of timepoints specified through the input/output module 14. The input/output module 14, the charting module 16, and the animation module 18 share data structures in memory 6.

The user inputs 20 indicate the source of price information to be used by the charting module 16 in creating the chart images in memory 6. The chart images could be derived from stored charting images 24 or (raw) price data 26. When the charting module 16 uses stored chart images 24, the user inputs 20 also include information that enables the chart module 16 to map between image pixel position and charted time and price values. The user inputs 20 may also include a specification of a set of timepoints to be used in the interactive presentation of the price charts. The specification of each timepoint may include commentary text. The user inputs 20 may also include a specification of a set of trading events, i.e., buy and sell points, which may or may not coincide with the timepoints.

In operation, the user enters information into the system 12 through the input/output module 14. The collected information, i.e., user inputs 20, along with other data generated by the system, is stored in a configuration file 28 and in the system program defaults 30. Based on the source of the price charts specified in the user inputs 20, the charting module 16 loads either stored chart images 24 or price data 26 into the system 12. In the latter case, the charting module 16 constructs the chart images in memory 6. The input/output module 14 renders the price charts on the screen 22. The charting module 16 and the animation module 18 use the data in memory 6 to present the price charts in a dynamic fashion, according to information specified in the user inputs 20.

B. User Interface

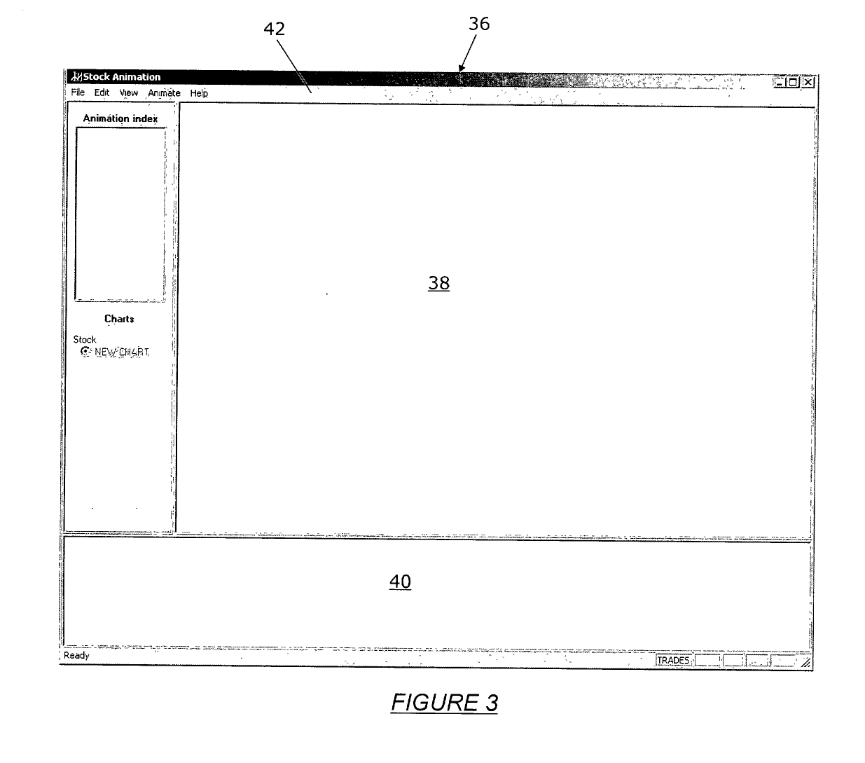

FIG. 3 shows a representative embodiment of an interface panel 36 for entering information into the system (12 in FIG. 2) and viewing the dynamic presentation of the chart images. The interface panel 36 is a part of the input/output module (14 in FIG. 2). The interface panel 36 includes a graphics area 38 for displaying a chart image and a text area 40 for entering and displaying timepoints and associated commentary text. The interface panel 36 includes a menu bar 42 having a set of menus. The menus on the menu bar 42 include commands that can be activated to cause the system to perform selected actions. For example, the “File” menu on the menu bar 42 includes a “New” action that can be used to create a new configuration file (28 in FIG. 2). The configuration file contains all the saved information associated with a particular dynamic presentation, with the exception of the program defaults (30 in FIG. 2), price data (26 in FIG. 2), and stored chart images (24 in FIG. 2), all of which are stored separately.

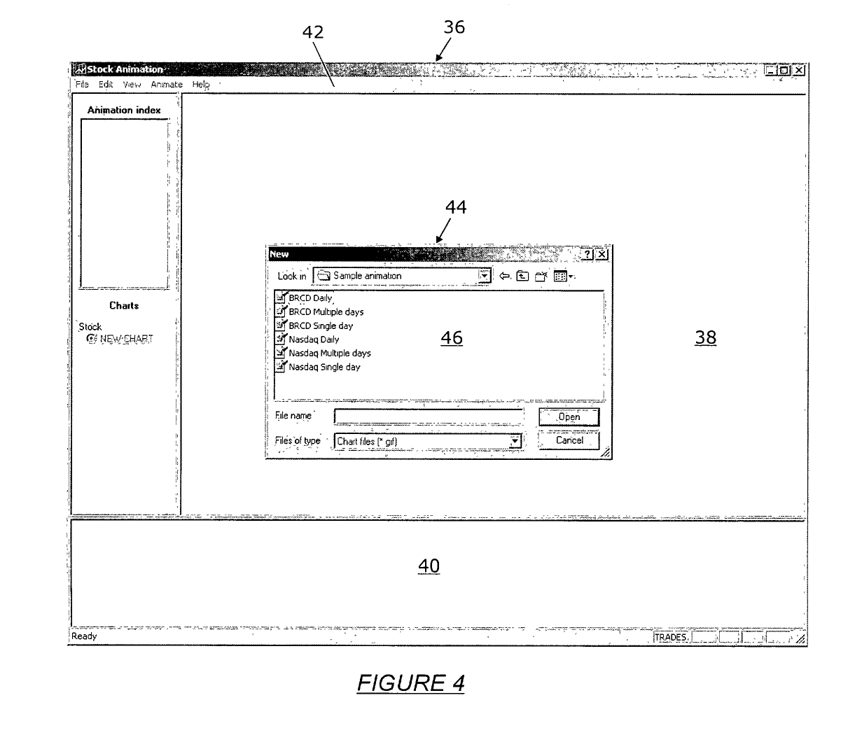

FIG. 4 shows a dialog window 44 that could be displayed when the user selects the “New” action from the “File” menu on the menu bar 42. The file dialog 44 includes a window area 46 for displaying the contents of a selected directory, which may be a local or a remote directory. In the illustration, the selected directory contains three files for the stock symbol BRCD (“Brocade Communication Systems, Inc.”). The three files contain images, respectively, of a daily chart, a multi-day (five-minute interval) chart, and a one-day (one-minute interval) chart. The selected directory also contains three analogous files for the symbol COMPX (“The Nasdaq/NMS Composite Index”). The user can select from among the files for the stock symbol BRCD and a new configuration file (28 in FIG. 2) will be created for the stock symbol BRCD. Later, when the configuration file is subsequently opened, all of the stored charts to which the configuration file refers will be loaded by the charting module (16 in FIG. 2) into the system.

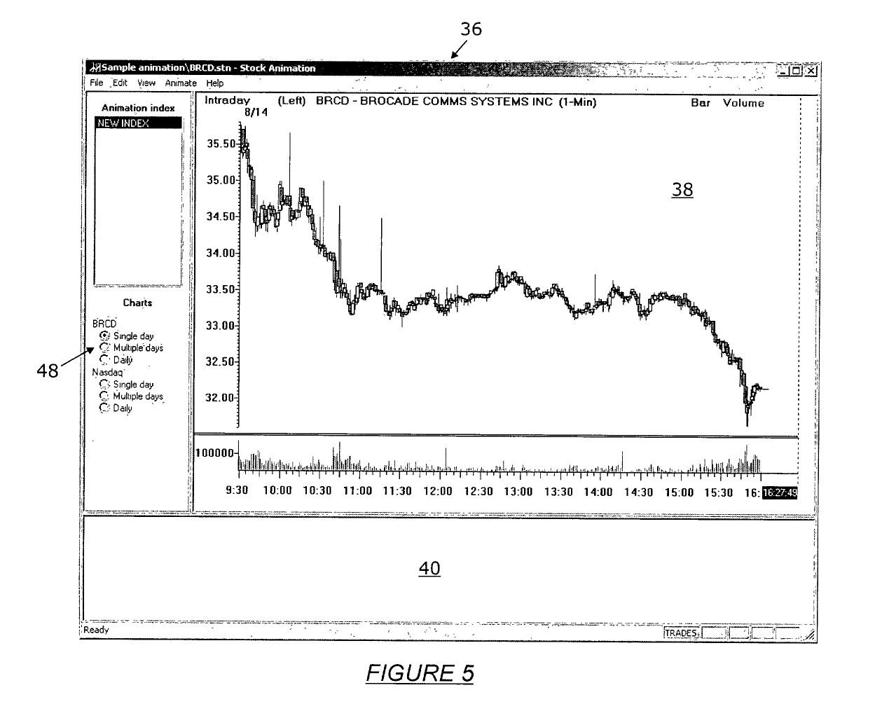

FIG. 5 shows the interface panel 36 after a new configuration file (28 in FIG. 2) has been created, in this case for the stock symbol BRCD. The interface panel 36 includes a set of chart radio buttons 48. Each of the chart radio buttons 48 is active (i.e., can be selected by the user) only if a chart image has been created in the system (12 in FIG. 2) and associated with the button. Neither the method(s) by which a stored chart image (24 in FIG. 2) is loaded into the system, nor the method(s) by which a chart image is built from price data (26 in FIG. 2), are important to understanding the principles of the invention, and thus are not described. When the user selects any of the active radio buttons 48, the corresponding chart image is displayed in the graphics area 38. In FIG. 5 the radio button 48 corresponding to the “BRCD Single day” chart image is selected, and the “BRCD Single day” chart image is displayed in the graphics area 38.

C. Methods for Manipulating Stored Charts

When a stored chart image is loaded into the system (12 in FIG. 2), the image is held in system memory (6 in FIG. 2). Without loss of generality, we assume that the chart image is rectangular-shaped and held in system memory as a two-dimensional array of pixels, of array size W by V, where W is an integer representing the width (i.e., horizontal size) of the image in pixels, and V is an integer representing the height (i.e., vertical size) of the image in pixels. Under this assumption, each image pixel location can be uniquely identified by a pair of integer values (X,Y), referred to herein as an “image location,” where X is the horizontal image pixel offset as computed from left-hand edge of the image, subject to constraint 0≦X≦(W−1), and Y is the vertical image pixel offset as computed from the bottom edge of the image, subject to constraint 0≦Y≦(V−1). The terms “horizontal image location” and “vertical image location,” as used herein, refer to horizontal and vertical pixel offsets, respectively, which satisfy the above constraints.

For stored chart images, the system (12 in FIG. 2) assumes that (1) the image displays an axis, referred to herein as the “charted time axis,” which is parallel with the lower edge of the image and displays a marked range of time values; (2) the image displays an axis, referred to herein as the “charted price axis,” which is parallel with the left-hand edge of the image and displays a marked range of price values; (3) the charted time and price axes are orthogonal within the image. The term “charted time value,” as used herein, refers to a time value which falls within the range indicated by the charted time axis; similarly, the term “charted price value,” as used herein, refers to a price value which falls within the range indicated by the charted price axis.

The term “horizontal chart reference point,” as used herein, refers to a pair (X,T) representing a horizontal image location and charted time value for a chart image; similarly, the term “vertical chart reference point,” as used herein, refers to a pair (Y,P) representing a vertical image location and charted price value for a chart image.

When a stored chart image is loaded into the system (12 in FIG. 2), beyond the assumptions listed above, the system has no knowledge of any association of image locations with charted time and price values. However, in order to create an interactive presentation of the chart images, it is necessary to map between image location and charted time and price values.

The following two sections, titled “Time Translation” and “Price Translation” describe specific methods for mapping between image location and charted time and price values. In the following discussion, the exact specification of “time” and “price” is not important to understanding the principles of the invention. For example, the following assumptions could be made: (1) for an intra-day chart, “time” means hours and minutes, (2) for a daily chart, “time” means month, day-of-month, and year, and (3) for either an intra-day chart or a daily chart, “price” means value in U.S. currency (i.e., dollars and cents).

C1. Time Translation

Time translation involves two mappings: (1) mapping from horizontal image location to charted time value, and (2) mapping from time value to horizontal image location.

Mapping from Horizontal Image Location to Charted Time Value

A specific method of mapping from horizontal image location to charted time value for a chart image derived from a stored chart source will now be described. The method comprises two steps.

STEP 1: Compute a “time/pixel factor,” F, for the chart image, defined as the length of charted time associated with each image pixel. F is given by the following expression:

$$F = \frac{L}{X2 - X1} \qquad ( 1 )$$

where X1 and X2 indicate two distinct horizontal image locations for the chart image, and L is the length of charted time between X1 and X2. Without loss of generality it is assumed that X2>X1.

L in Equation (1) can be given directly as part of the user inputs (20 in FIG. 2). Alternatively, L can be computed indirectly by the charting module (16 in FIG. 2), e.g., from the user inputs. Possible scenarios for the indirect computation of L include, but are not limited to, the following:

1. If the chart image displays a daily chart, the user inputs can indicate date Ti associated with X1 and date T2 associated with X2. Then, with the aid of a calendar, the charting module (16 in FIG. 2) can compute L as number of days from T1 to T2.

2. If the chart image displays an intra-day chart showing a single day of price data or displays an intra-day chart showing multiple days of data and X1 and X2 correspond to charted times on the same day of charted data, and if the user inputs (20 in FIG. 2) indicate the charted times T1 and T2 at X1 and X2, respectively, then the charting module (16 in FIG. 2) can compute L as the number of minutes from T1 to T2 (i.e., by subtraction of the chart times):

L=T2−T1 (2)

3. If the chart image displays an intra-day chart showing multiple days of price data, with each charted day having the same beginning time B and ending time E, and the user specifies X1 and X2 on different days of charted data and the charted times T1 and T2 at X1 and X2, respectively, then the charting module (16 in FIG. 2) can compute the length of time L between X1 and X2 if the user additionally specifies (1) the number of trading days (Z>1) spanned by X1 and X2, and (2) the parameters B and E. Assuming B≦T1≦E and B≦T2≦E, then L can be obtained from the following expression:

L=T2−T1+(E−B)(Z−1) (3)

Note that when Z=1, Equation (3) reduces to Equation (2) above.

STEP 2: Once F is computed, given a horizontal chart reference point (X3, T3) for the chart image, an arbitrary horizontal image location X can be mapped to its associated charted time value T using the following expression:

T=T3+F(X−X3) (4)

Note that X3 does not need to be distinct from the X1 and X2 values used in Step 1 (i.e., X3=X1 or X3=X2 is permitted).

Adjustment to the computation result given in the right-hand side of Equation (4) may be required before T is reported. Such adjustment may include, but are not limited to, the following:

1. If the result is not a discrete value, the result can be rounded in some manner, e.g., to the nearest minute.

2. For the case in which the chart image shows multiple days of charted data and X3 and X in Equation (4) refer to different days of charted data, the result may fall outside the range [B,E]. In that case the result can be adjusted as follows: if the result exceeds E then repeatedly subtract (E−B) until the result is in the range [B,E], else if the result is less than B then repeatedly add (E−B) until the result is in the range [B,E].

### EXAMPLES

Given: (1) a chart image displaying daily price data, with width 800 pixels, and (2) horizontal chart reference points (X1,T1)=(300,12/01/2001) and (X2,T2)=(550,02/01/2002). Find the charted time T corresponding to horizontal image location X=352.

First, compute the time/pixel factor F using Equation (1). L is computed by Equation (2) as L=(T2−T1)=62 days. Therefore, F=62 days/(550−300) pixels=0.248 days/pixel. Next, compute T by Equation (4) using either (X1,T1) or (X2,T2) as the horizontal chart reference point. Using (X1,T1), T is computed as T=T1+F(X−X1). The intermediate computation F(X−X1)=0.248(352−300)=12.986 days can be rounded to 13 days. Thus the charted time T is computed as T=12/01/2001+13 days=12/14/2001.

Given: (1) a chart image displaying one day of intra-day price data, with width 800 pixels, and (2) horizontal chart reference points (X1,T1)=(300,10:15) and (X2,T2)=(550,12:24). Find the charted time T corresponding to horizontal image location X=250.

First, compute the time/pixel factor F, using Equation (1). L is computed by Equation (2) as L=(T2−T1)=129 min. Therefore, F=129 min/(550−300) pixels=0.516 min/pixel. Next, compute T using either (X1,T1) or (X2,T2) as the horizontal chart reference point. Using (X1,T1), T is computed as T=T1+F(X−X1). The intermediate computation F(X−X1)=0.516(250−300)=−25.8 min can be rounded to −26 min. Thus the charted time T is computed as T=10:15−26 min=09:49.

Given: (1) a chart image displaying five days of intra-day price data, with width 800 pixels, (2) horizontal chart reference points (X1,T1)=(300,11:15) and (X2,T2)=(550,9:45), (3) T1 and T2 spanning Z=3 days, and (4) each day of charted data beginning at B=9:30 and ending at E=16:00. Find the charted time T corresponding to horizontal image location X=500.

First, compute the time/pixel factor F using Equation (1). L is computed by Equation (3) as L=(T2−T1)+(E−B)(Z−1)=(9:45−11:15)+(16:00−9:30)(3−1)=11:30. Therefore, F=11:30/(550−300)=690 min/250 pixels=2.76 min/pixel. Next, compute T by Equation (4) using either (X1,T1) or (X2,T2) as the horizontal chart reference point. Using (X1,T1), T is computed as T=T1+F(X−X1). The intermediate computation F(X−X1)=2.76(500−300)=552 min=9:12. Thus the charted time T is computed as T=T1+9:12=11:15+9:12=20:27. This value exceeds E, so (E−B) is subtracted (potentially repeatedly) until the value falls in the range [B,E]: 20:27−(16:00−9:30)=13:57. This value falls within the range [9:30,16:00], so T=13:57 is reported as the result.

Mapping from Time Value to Horizontal Image Position

A specific method of mapping a time value to a horizontal image position for a chart image derived from a stored chart source will now be described. Given a time value T, horizontal chart reference point (X1,T1) and time/pixel factor F for the chart image (computed via Equation (1)), the horizontal image location X associated with T can be computed as:

$$X = X1 + \frac{T - T1}{F} \qquad ( 5 )$$

Adjustment to the computation result given in the right-hand side of Equation (5) may be necessary before X is reported, including, but not limited to:

(1) Rounding of the result. Since an integral value is required in order to reference a horizontal image location, any non-integral result of this computation would be rounded to the nearest integer.

(2) Boundary conditions. When the results of the computation need to satisfy a boundary condition constraint but do not, X can either be reported as undefined or set to a valid horizontal image location. For example, when W is the chart width and the constraint is 0≦X≦(W−1), when the results of the computation fall outside of this range, X could be reported as either 0 or (W−1).

(3) Intra-day chart showing multiple days of data. The computation above will indicate a horizontal image location on the same charted day of data as the horizontal chart reference point. For other valid horizontal image locations (i.e., on other charted days), some adjustment is necessary, the details of which are not addressed here.

### EXAMPLES

Given: (1) a chart image displaying a single day of intra-day price data, with width 900 pixels, and (2) horizontal chart reference points (X1,T1)=(200,10:15) and (X2,T2)=(450,12:24). The time/pixel factor F is computed using Equations (1) and (2) as F=L/(X2−X1)=(12:24−10:15)/(450−200)=0.516 min/pixel.

Find horizontal image location X corresponding to time T=14:50. Using Equation (5), X is computed as X=X1+(T−T1)/F=200 pixels+(14:50−10:15)/(0.516 min/pixel)=732.9457 pixels. The result is rounded to 733 pixels and reported as X.

Find horizontal image location X corresponding to time T=17:15. Using Equation (5), X is computed as X=X1+(T−T1)/F=200 pixels+(17:15−10:15)/(0.516 min/pixel)=1013.9534 pixels. This value can be rounded to 1014 pixels. This value exceeds the image width, so X can either be reported as undefined or (by applying the boundary condition 0≦X≦899) as 899.

Summary of Time Translation

Time translation for a chart image derived from a stored chart source comprises two mappings. The first mapping, from horizontal image location X to charted time value T, involves computing the time/pixel factor F and then using X, F, and a horizontal chart reference point (X3, T3) to determine T. The second mapping, from time value T to horizontal image location X, involves computing the time/pixel factor F and then using T, F, and a horizontal chart reference point (X3, T3) to determine X.

Referring to FIG. 2, in order for the charting module 16 in the system 12 to perform time translation, the user inputs 20 must specify (1) two distinct horizontal image locations X1 and X2 for the chart image, (2) the length of charted time L between X1 and X2, either directly or by specification of information which the charting module 16 can use to compute L, and (3) a horizontal chart reference point (X3, T3), where X3=X1 or X3=X2 is allowed. Note that if the user inputs 20 specify two horizontal chart reference points (X1,T1) and (X2,T2) and the charting module 16 can compute L from these, then sufficient information exists for the system 12 to perform time translation.

C2. Price Translation

Price translation involves two mappings: (1) mapping from vertical image location to charted price value, and (2) mapping from price value to vertical image location.

Mapping from Vertical Image Location to Charted Price Value

A specific method of mapping from vertical image location to charted price value for a chart image derived from a stored chart source will now be described. The method comprises two steps.

STEP 1: Compute a “price/pixel factor,” H, for the chart image, defined as the magnitude of charted price associated with each image pixel. H is given by the following expression:

$$H = \frac{D}{Y2 - Y1} \qquad ( 6 )$$

where Y1 and Y2 indicate two distinct vertical image locations for the chart image, and D is the magnitude of charted price between Y1 and Y2. Without loss of generality it is assumed that Y2>Y1.

D in Equation (6) can be given directly as part of the user inputs (20 in FIG. 2). Alternatively, D can be computed indirectly by the charting module (16 in FIG. 2), e.g., from the user inputs. A possible method for the indirect computation of D includes, but is not limited to, the specification in the user inputs of price P1 associated with Y1 and price P2 associated with Y2, in whatever unit appropriate, e.g., dollars and cents. In this case the charting module can compute D via subtraction of these values, i.e., D (P2−P1).

STEP 2: Once H is computed, given a vertical chart reference point (Y3, P3) for the chart image, an arbitrary vertical image location Y can be mapped to its associated charted time P using the following expression:

P=P3+H(Y−Y3) (7)

Note that Y3 does not need to be distinct from the Y1 and Y2 values used in Step 1 (i.e., Y3=Y1 or Y3=Y2 is permitted).

Adjustment to the computation result given in the right-hand side of Equation (7) may be required before P is reported. Such adjustment may include, but is not limited to, the following: If the result is not a discrete value, the result can be rounded in some manner, e.g., to the nearest cent.

### EXAMPLE

Given: (1) a chart image with height 600 pixels, (2) vertical chart reference points (Y1,P1)=(300,$82.50) and (Y2,P2)=(550,$100.35). Find the charted price P corresponding to vertical image location Y=401.

First, compute the price/pixel factor H using Equation (6). D is computed as D=(P2−P1)=($100.35−$82.50)=$17.85. Therefore, H=$17.85/(550−300) pixels=$0.0714/pixel. Next, using Equation (7), compute the charted time value P using either (Y1,P1) or (Y2,P2) as the vertical chart reference point. Using (Y1,P1), P is computed as P=P1+H(Y−Y1). The intermediate computation is H(Y−Y1)=0.0714(401−300)=$7.21. Thus the charted price P is computed as P=$82.50+$7.21=$89.71.

Mapping from Time Value to Vertical Image Position

A specific method of mapping a time value to vertical image position for a chart image derived from a stored chart source will now be described. Given a price value P, vertical chart reference point (Y1,P1) and price/pixel factor H for the chart image (computed via Equation (6)), the vertical image location Y associated with P can be computed as:

$$Y = Y1 + \frac{P - P1}{H} \qquad ( 8 )$$

Adjustment to the computation result given by the right-hand side of Equation (8) may be necessary before Y is reported, including, but not limited to:

(1) Rounding of the result. Since an integral value is required in order to reference a vertical image location, any non-integral result of this computation would be rounded to the nearest integer.

(2) Boundary conditions. When the results of the computation need to satisfy a boundary condition constraint but do not, Y can either be reported as undefined or set to a valid vertical image location. For example, when V is the chart height in pixels and the constraint is 0≦Y≦(V−1), when the results of the computation fall outside of this range, Y could be reported as either 0 or (V−1).

### EXAMPLE

Given: (1) a chart image with height 600 pixels, and (2) vertical chart reference points (Y1,P1)=(300,$82.50) and (Y2,P2)=(550,$100.35). The price/pixel factor H is computed using Equation (6) as H=D/(Y2−Y1)=($100.35−$82.50)/(550−300) $0.0714/pixel.

Find vertical image location Y corresponding to price value P=$75. From Equation (8), Y is computed as Y=Y1+(P−P1)/H=300 pixels+($75−$82.50)/($0.0714/pixel)=194.9580 pixels. The result is rounded to 195 pixels and reported as Y.

Summary of Price Translation

Price translation for a chart image derived from a stored chart source comprises two mappings. The first mapping, from vertical image location Y to charted price value P, involves computing the price/pixel factor H and then using Y, H, and a vertical chart reference point (Y3, P3) to determine P. The second mapping, from price value P to vertical image location Y, involves computing the price/pixel factor H and then using P, H, and a vertical chart reference point (Y3, P3) to determine Y.

Referring to FIG. 2, in order for the charting module 16 in the system 12 to perform price translation, the user inputs 20 must specify (1) two distinct vertical image locations Y1 and Y2 for the chart image, (2) the magnitude of charted price value D between Y1 and Y2, either directly or by specification of information which the charting module 16 can use to compute D, and (3) a vertical chart reference point (Y3, P3) for the chart image, where Y3=Y1 or Y3=Y2 is allowed. Note that if the user inputs 20 specify two vertical chart reference points (Y1,P1) and (Y2,P2) and the charting module 16 can compute D from these, then sufficient information exists for the system 12 to perform price translation.

C3. Method of Specifying Chart Reference Points

As described above, time translation and price translation require the specification of chart reference points. The system (12 in FIG. 2) allows the user to specify horizontal and vertical chart reference points for a chart image derived from a stored chart source (24 in FIG. 2), and saves the specified reference points as part of the user inputs (20 in FIG. 2). The following is a description of the method of specifying the chart reference points in one representative embodiment of the system, using the interface panel (36 in FIG. 3) shown earlier.

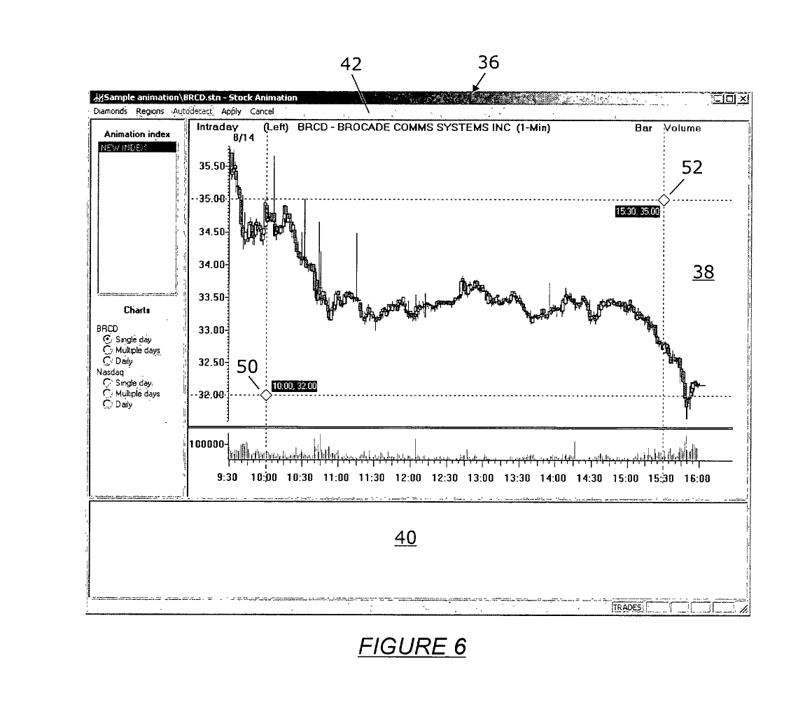

FIG. 6 displays the interface panel 36 after a configuration file (28 in FIG. 2) for stock symbol BRCD has been loaded. When the user selects the appropriate command from the menu bar 42, two diamond-shaped reference locators 50, 52 are displayed on the chart image displayed in the graphics area 38. The user can reposition the reference locators 50, 52 to desired locations on the chart image using, for example, a pointing device, such as the mouse 7 in FIG. 1. Each reference locator 50, 52 has a time and a price property. In the illustration, the chart image displayed in the graphics area 38 shows a single day of intra-day price data. Thus, the time property associated with the reference locators 50, 52 is given as an hour and minute value (e.g., 10:00). If the chart image shown in the graphics area 38 were a daily chart, the time property would be given as a month, day and year value (e.g., 08/14/2000).

After positioning the reference locators 50, 52 at locations on the chart image corresponding to axis-marked time and price values, the user sets the time and price properties of the reference locators 50, 52 to the axis-marked values. In the illustration, the time and price properties of the reference locator 50 are set to 10:00 and 32.00, respectively, and the time and price properties of reference locator 52 are set to 15:30 and 35.00, respectively. Once this process is completed for both reference locators, four chart reference points are established in the user inputs (20 in FIG. 2) by the charting module (16 in FIG. 2) by computing the image locations of the reference locators on the displayed chart image. For example, suppose reference locator 50 has been positioned at image location (120,175) and reference locator 52 has been positioned at horizontal image location (752,450). Then, horizontal chart reference point (120,10:00) and vertical chart reference point (175,32.00) now exist, due to reference locator 50, and horizontal chart reference point (725,15:30) and vertical chart reference point (450,35.00) now exist, due to reference locator 52.

The entire process described above is repeated for each chart image loaded into the system (12 in FIG. 2). Once complete, the charting module (16 in FIG. 2) can compute the necessary parameters L and D for each chart image indirectly from the two specified reference locators for the chart image and other constraints that are imposed or other information that is made available. In one embodiment, for an intra-day chart image, the reference locators 50, 52 must be positioned on the same day of charted price data, and the charting module computes L as the number of charted minutes between the two reference locators by subtracting the values given in their time properties; for reference locators positioned on a daily chart image, the charting module has access to a calendar and computes L as the number of days between the dates given as the time properties of the reference locators. For D, the charting module assumes that direct subtraction of the values given as the price properties of the reference locators will yield the magnitude of charted price between the two locators.

Thus, for one embodiment of the invention, once the two chart reference locators are specified for a chart image, the charting module (16 in FIG. 2) can compute the associated parameters L, F, D, and H, and can thus perform time and price translation for the chart image.

C4. Partial-Chart Display

The interactive presentation of the chart images involves displaying the chart images as they would appear at specific timepoints, i.e., partially displaying the chart images. More generally, the term “partial-chart display,” as used herein, refers to the visual effect achieved for a chart image derived from a stored chart source when only the portion of the chart image, up to a specified time value or horizontal image location, is made visible. When a time value is specified, the system (12 in FIG. 2) uses time translation to determine the corresponding image portion to display. When a horizontal image location is specified, the system can use time translation to determine the associated charted time value, e.g., for display to the user.

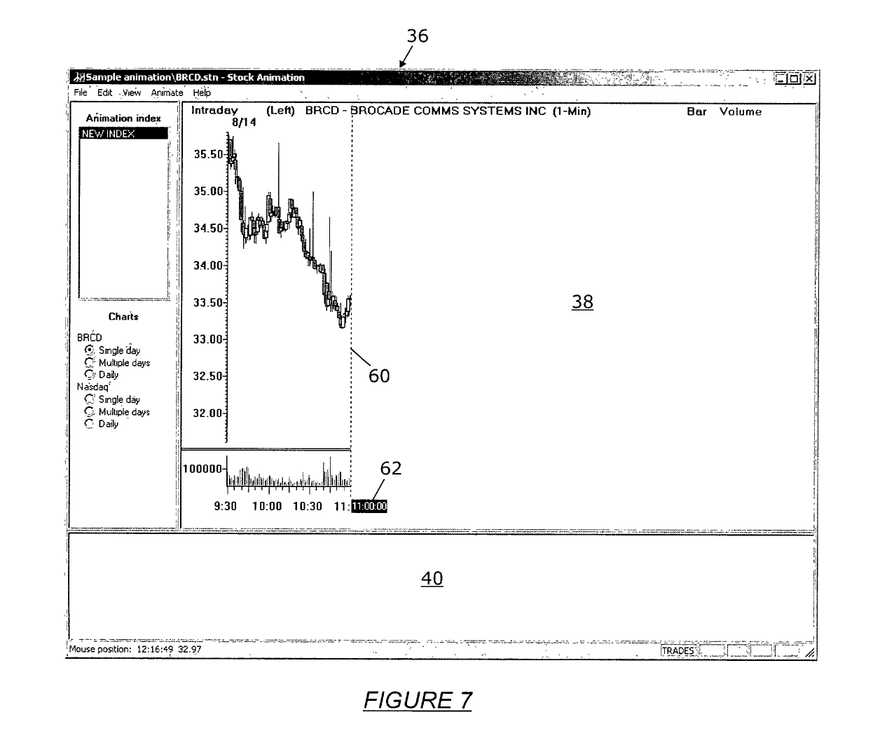

As shown in FIG. 7, in one representative embodiment of the invention, the interface panel 36 allows a user to flexibly position a vertical dashed line 60 spanning the height of the chart image and thereby indicate a specific horizontal image location. To the right of the dashed line 60, no chart image is shown. The charted time value T associated with the location of the vertical dashed line 60 is displayed in an adjacent tag 62. The partial-chart display in the graphics area 38 is a visual approximation of how the single-day intra-day price chart for BRCD looked in the original charting application at 11:00:00 on Aug. 14, 2000.

Various methods can be used to achieve partial-chart display. One method is to overlay a second image, with a solid color matching the background color of the chart image, on top of the chart image and to the right of the user-specified horizontal image location or time value (i.e., to the right of the position of the vertical dashed line 60 in FIG. 7). Another method is to display on the screen (22 in FIG. 2) only a portion of the chart image, up until the user-specified horizontal image location or time value, essentially truncating the chart image there. Other methods for achieving this or similar visual effects are possible.

D. Trade Events

The term “trade event,” as used herein, refers to a combined specification of values, including, but not limited to, time, price, and action. “Time” is given as any valid time specification, which may include date, hour, minute, and seconds. “Price” is given usually, but not necessarily, as a real value greater than zero. “Action” is given usually, but not necessarily, as “Buy” or “Sell.” For example, the trade event “(12:15, $55.20, Buy)” indicates that at 12:15 on some unspecified date, some number of shares of a stock are bought at a price of $55.20.

The system (12 in FIG. 2) supports the creation and manipulation of trade events.

D1. Creation of Trade Events

Two methods are provided for the creation of an individual trade event. All trade events, once created, are stored by the system in the configuration file (28 in FIG. 2) for later retrieval.

First method. The first method involves user interaction with the interface panel (e.g., 36 in FIG. 5) to specify the three values needed. The specification could be done via dialog window in which the user enters the necessary values, or by some combination of mouse (7 in FIG. 1) and keyboard (8 in FIG. 1) operation, or by some other interface operation. This method of specifying trade events is useful, e.g., when the user is experimenting with trade strategy formation and wishes to place trade events on the chart image in an unconstrained fashion.

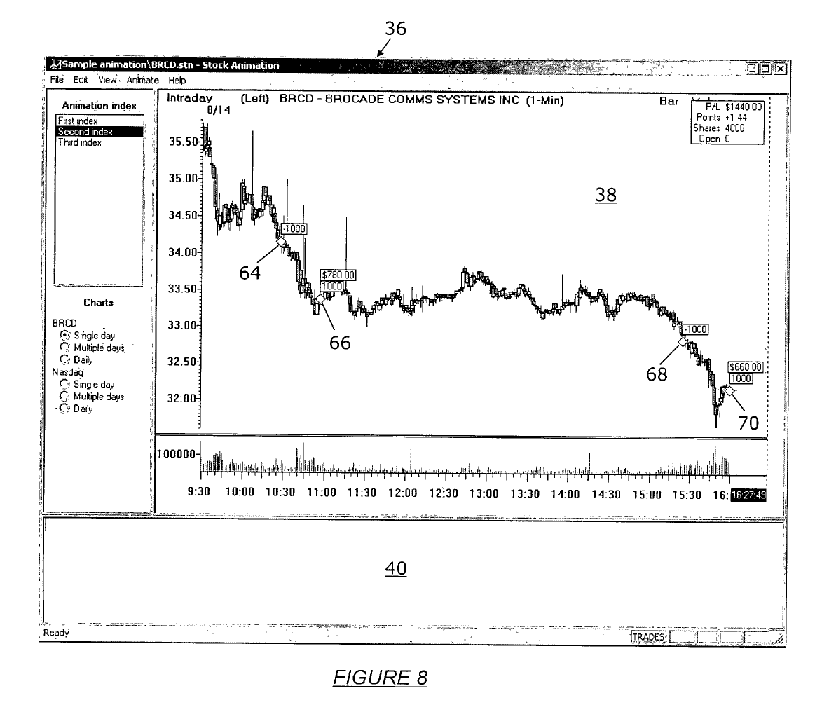

In one representative embodiment, in which chart images are derived from stored chart sources, the system (12 in FIG. 2) requires an intra-day chart image to be displayed in graphics area of the interface panel (e.g., area 38 in FIG. 8) in order for the user to create a trade event. The user can initiate the creation of a trade event by clicking the mouse (7 in FIG. 1) on the chart image displayed in the graphics area. The mouse click indicates a particular image location, from which the system derives the time and price properties of the trade event using time and price translation. (If the chart images in this embodiment were instead rendered from price data (26 in FIG. 2), the derivation of time and price properties for the trade event would be done using information stored by the charting module (16 in FIG. 2) when rendering the chart image.) The mouse operation invokes a dialog menu from which the user can then select “Buy” or “Sell” to specify the action property of the trade event. Once the action property is selected, the trade event is created.

Second method. The second method for creating individual trade events involves reading the necessary information from a file, referred to herein as a “trade file” (32 in FIG. 2), containing the necessary information.

This method is useful in practice since most trading platforms produce a log file of trade events which occur during the trading day (or such a log file can be easily constructed, for example, by electronically copying the necessary information from the brokerage trading records), and afterwards the trader would typically like to visually display these trade events (i.e., plotted onto chart images) for after-the-fact trade analysis. In the prior art, to visually display trade events for after-the-fact trade analysis, the trader would have to obtain a physical printout of the chart and then plot the trading events on the printout by hand. This is a tedious endeavor and one which is a practical impossibility for a trader doing a high number of trades per day. The present invention makes it easy to plot trade events on chart images for after-the-fact trade analysis.

In one representative embodiment of the invention, the user can instruct the system (12 in FIG. 2) to create trade events by reading a text-formatted file which specifies one trade event per text line. Each trade event in this file must be given as a set of comma-separated values, individually indicating the trade event time, price and action, respectively.

D2. Manipulation of Trade Events

Trade events, once created, can be displayed by the system (12 in FIG. 2). FIG. 8 shows four trade events 64, 66, 68, 70 which have been defined and are shown on the chart image displayed in the graphics area 38 of the interface panel 36 of one representative embodiment of the invention. For each defined trade event, a diamond is displayed at the screen pixel location corresponding to the time and price values specified for the trade event. The two “Buy” trade events 64 and 68 have a display color (e.g., blue) which is distinct from the display color (e.g., yellow) used for “Sell” trade events 66 and 70.

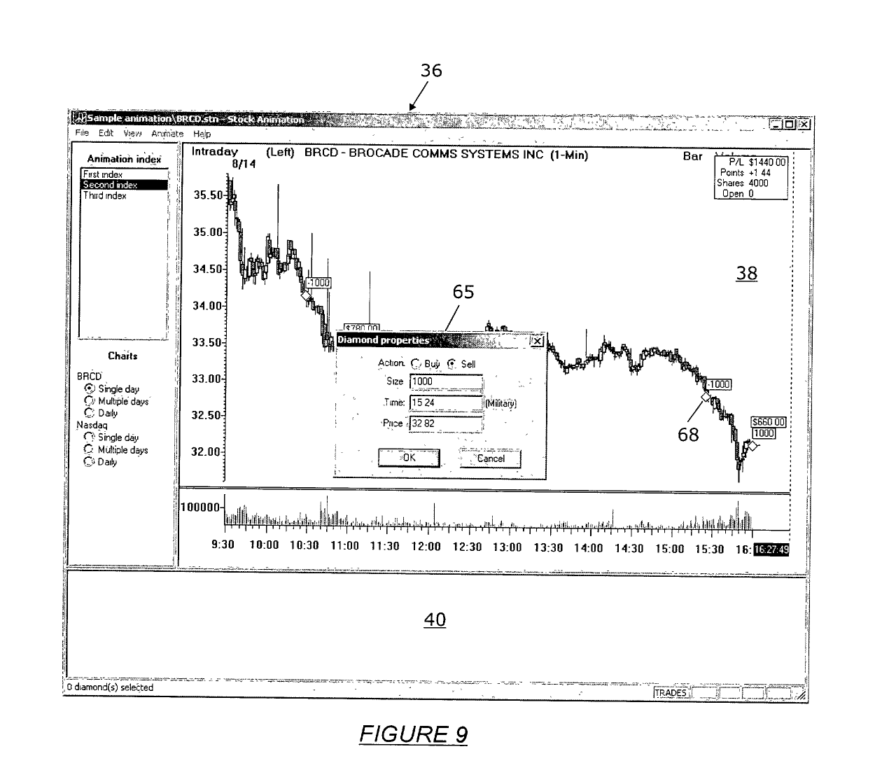

The system (12 in FIG. 2) allows the user to modify the properties of a defined trade event. In one representative embodiment, the user can modify the time and price properties of a displayed trade events by relocating the associated displayed diamond to new image location using the mouse (7 in FIG. 1), after which the system determines the new time and price values for the trade event from the new location. Alternatively, the user can directly edit any of the trade event properties using a dialog window in the interface panel. FIG. 9 shows the dialog window 65 invoked for editing the properties of trade event 68 (also shown in FIG. 8). When the user changes the time or price property for a trade event via the dialog window 65, the system determines a new location for the display of the diamond associated with the trade event. If the chart image was derived from a stored chart source (24 in FIG. 2), the system determines the new location using time and price translation. If the chart image was constructed from price data (26 in FIG. 2), the system determines the new location using information stored by charting module (16 in FIG. 2) when the chart image was constructed.

E. Chart Animation

The term “chart animation,” as used herein, refers to the creation and “animation” of one or more “timestamp” sequences.

E1. Creation of a Timestamp Sequence

The term “timestamp,” as used herein, refers to some indication of a charted image time, usually, but not necessarily, specified by a time value or horizontal image location. For example, for a chart image showing a single day of intra-day price data, the timestamp could be “14:55:32” or “horizontal image location 523”. The exact form of the timestamp is not important to understanding the principles of the invention.

The system (12 in FIG. 2) allows the user to create individual timestamps. Each timestamp is stored in the configuration file (28 in FIG. 2). The user may create a timestamp for a variety of reasons. For example, the timestamp may refer to a point on the chart image of particular interest from a technical perspective, e.g., because that point represents the completion of the formation of a significant technical pattern. The point could indicate the time at which a trading action is recommended according to some trading strategy or the time where a trading action was taken during the trading day.

The system (12 in FIG. 2) provides the ability to create one or more sequences (i.e., ordered groups) of timestamps. The ordering of each sequence can be arbitrarily specified. The sequence is stored in the configuration file (28 in FIG. 2) for later retrieval. Potential uses for timestamp sequences include, but are not limited to, (1) illustration of a particular trading strategy, (2) illustration of the analysis of sequence of actual trade events, e.g., when a different timestamps is associated with each trade event, and (3) illustration of the analysis of some portion of the trading day.

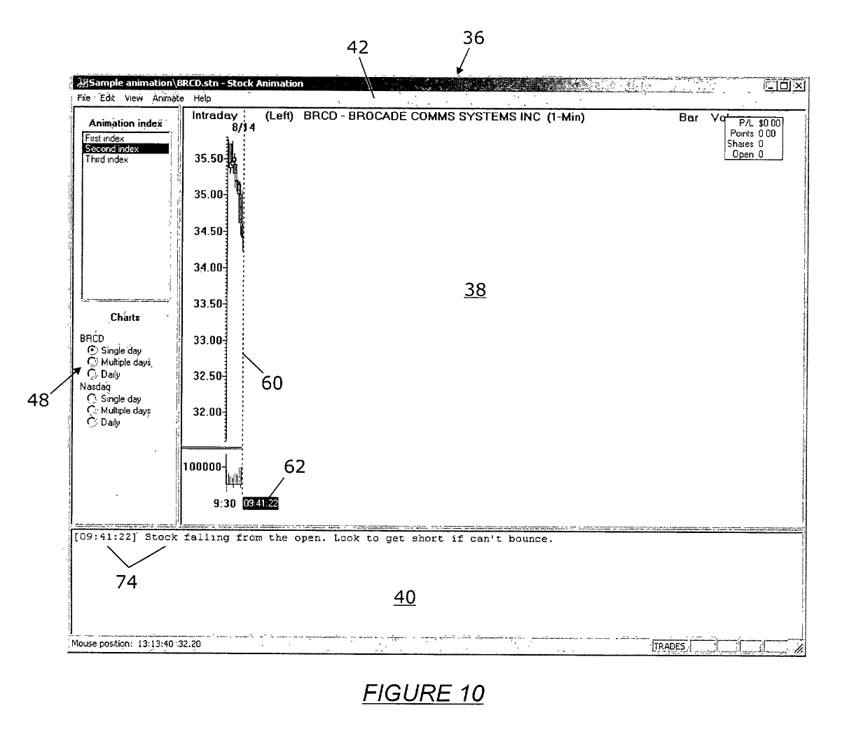

Referring to FIG. 10, the following is a discussion of the process whereby the user can specify a timestamp sequence, for the interface panel 36 of one representative embodiment of the system (12 in FIG. 2). In this embodiment, chart images are derived from stored chart sources.

STEP 1. The user selects an intra-day chart from among the chart radio buttons 48. (This implementation of the system requires that an intra-day chart image be displayed in the graphics area 38 in order for a timestamp to be created). In the illustration, the chart image displayed in the graphics area 38 is the intra-day chart for the stock symbol BRCD, showing a single day of charted data.

STEP 2. The user specifies a timestamp by one of two methods:

The user adjusts the horizontal position of the vertical dashed line 60 to a desired horizontal image location, and then selects the “Timestamp” command from the Edit menu on the menu bar 42. The system (12 in FIG. 2) performs time translation to determine the charted time associated with the selected horizontal image location and then inserts a text string representation of this time into the text area 40, using special format “[HH:MM:SS]” (e.g., “[09:52:04]”). The double-quote marks are not part of the special format.

Alternatively, the user can enter a timestamp text string directly into the text area. However, when doing so, the user must be careful to follow the specified text format in order for the timestamp to be valid.

The user can optionally enter commentary text into the text area 40 directly following the timestamp, e.g., “Stock falling from the open. Look to get short if can't bounce.”

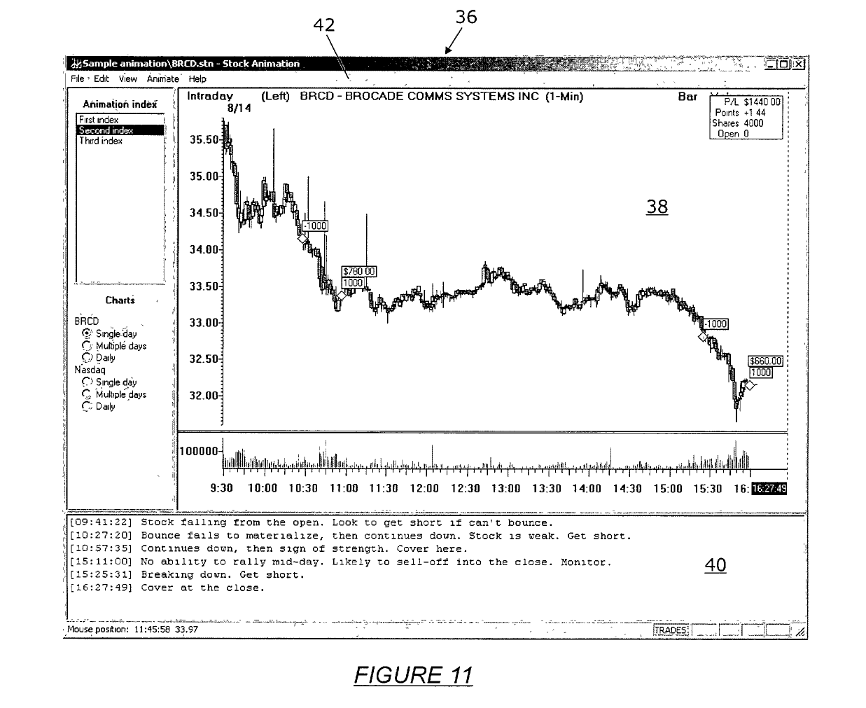

STEP 3. The user repeats Step 2 as many times as desired, with each iteration creating a new timestamp. FIG. 11 illustrates the process repeated five times, for a sequence of six timestamps created in the text area 40. (Although FIG. 11 illustrates timestamps ordered according to increasing timestamp value, this is not a necessary constraint). In addition, FIG. 11 illustrates the creation of trade events at appropriate locations on the chart image in order to demonstrate the trading strategy recommended in the commentary text.

E2. Animation of a Timestamp Sequence

The term “animation”, as used herein with respect to a timestamp sequence, refers to the process, as carried out by the animation module (18 in FIG. 2) component of the system (12 in FIG. 2), which includes, but is not limited to, the following steps:

STEP 1. The animation module iteratively selects individual timestamps from the timestamp sequence.

STEP 2. For each selected timestamp, the animation module performs time translation (if necessary) to determine the corresponding horizontal image location, and then performs partial-chart display using this horizontal image location (i.e., displays the current chart image up to but not beyond the charted time indicated by the timestamp).

STEP 3. At each step of the presentation, the animation module may accept input from the user, including, but not limited to, instruction to move forward in the sequence, backward in the sequence, or end the presentation.

For one representative embodiment of the system (12 in FIG. 2), the following is a discussion of the animation of a timestamp sequence. Consider FIG. 11, which displays the interface panel 36 of one representative embodiment of the system, with six timestamps defined in the text area 40. The user can activate the “Animate” command from the menu bar 42, to which the system responds by searching through the text area 40, starting from the first visible line of text, for a text sub-string matching the timestamp text format (“[HH:MM:SS]”). In this case the matching text is “[09:41:22]”. Once a match is found, the system reads the time value from the matched text and performs partial-chart display on the chart image based on this time value.

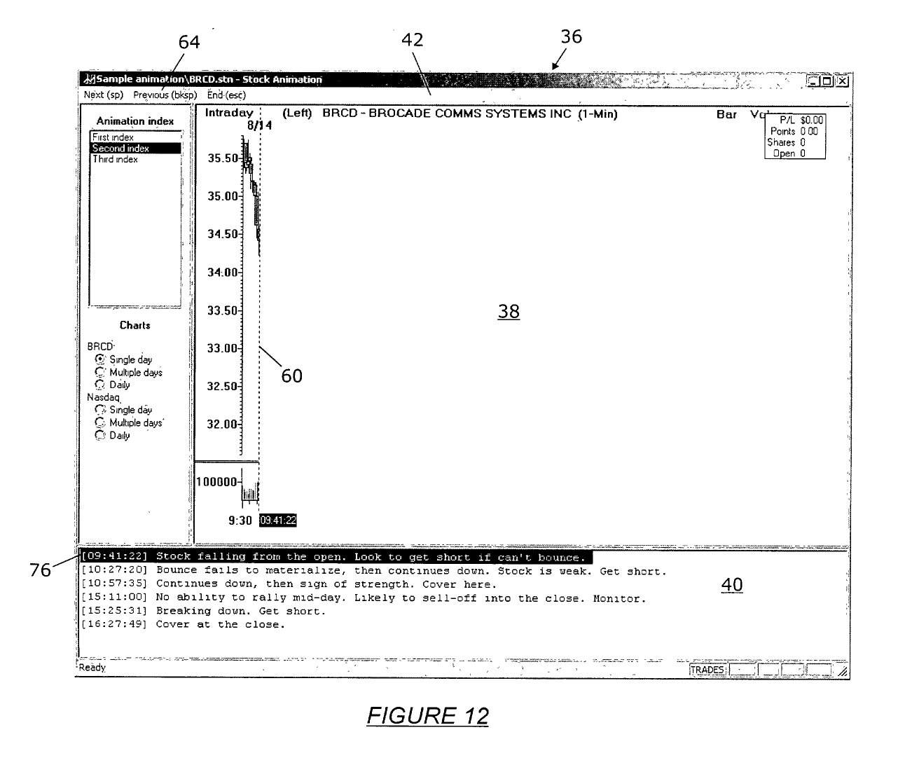

See FIG. 12 for an updated view of the interface panel 36 based on these actions. The system (12 in FIG. 2) displays the vertical dashed line 60 at the horizontal image location implied by the time value read from the matched text, with no chart image shown to the right of the vertical dashed line 60. In this representative embodiment, both the timestamp text and all commentary 76 in the text area 40 between the matched timestamp and the next occurrence of a timestamp in the text area 40 (or the end of the text area 40), are highlighted. The system then awaits user input.

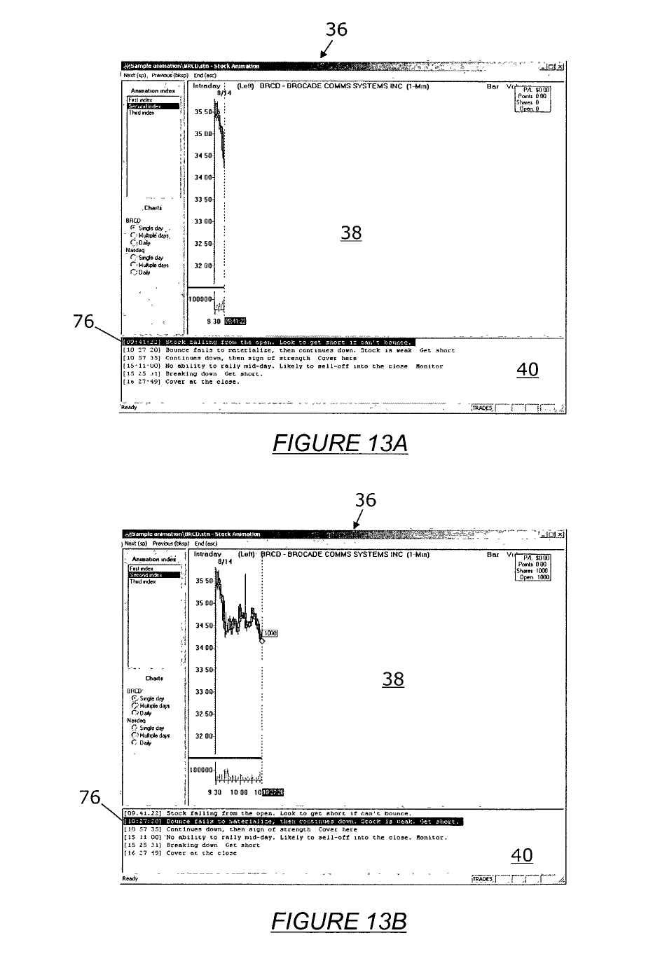

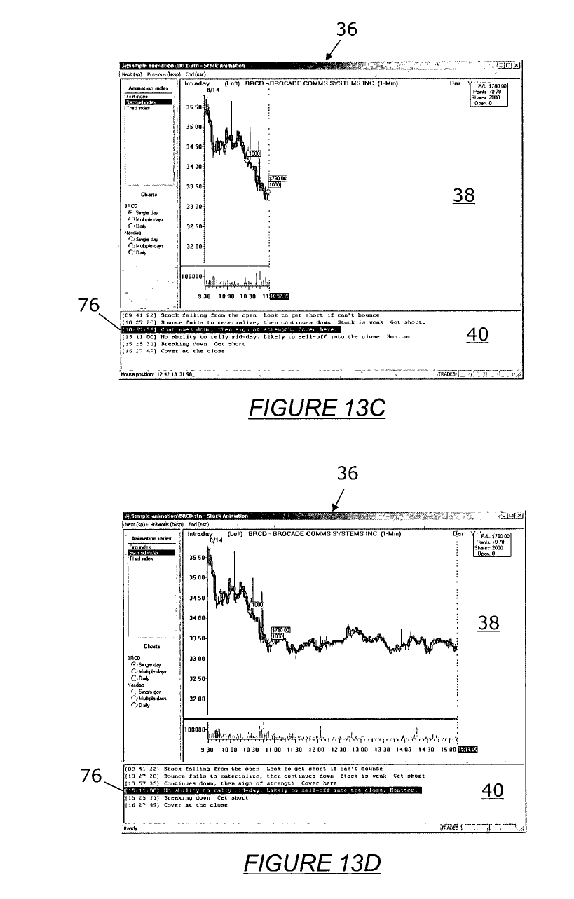

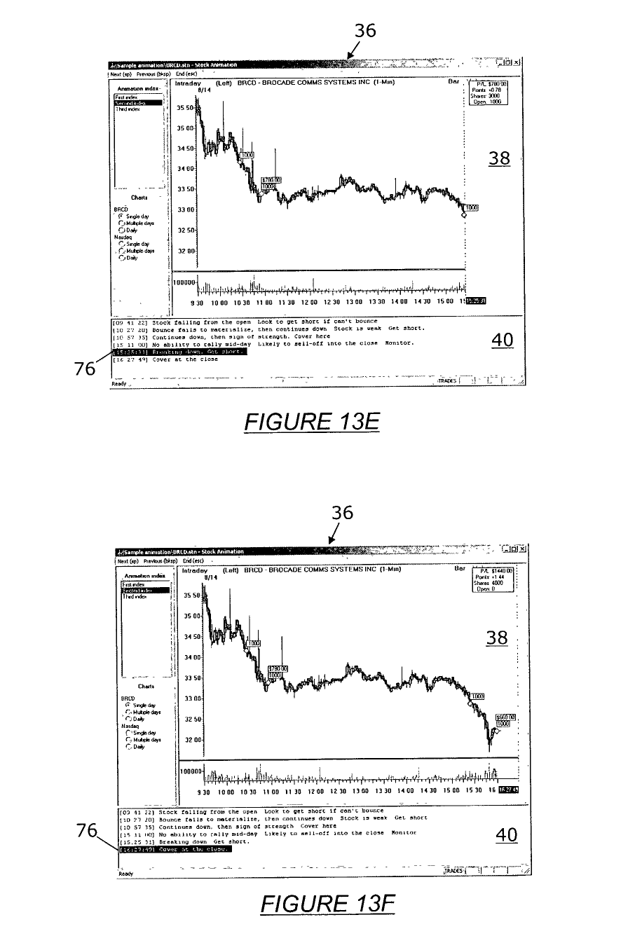

During the animated presentation, the user can instruct the system (12 in FIG. 2) to move the forward in the sequence, to move the backward in the sequence, or to exit, using the commands now on the menu bar (64 in FIG. 12). When so instructed, the system searches forward or backward in the text area (40 in FIG. 12), as appropriate, for the next occurrence of the timestamp format, taking no action if none is found. At each step, the chart image is displayed using partial-chart display with the time value associated with the current timestamp. FIGS. 13A-13F illustrate the process of stepping sequentially through the animation begun in FIG. 12. Note the timestamps highlighted in the text area 40 of each of the figures and the corresponding display in the graphics area 38.

F. Chart Rotation

“Chart rotation” refers to the rotation of any region of a chart image (possibly the entire image) vertically about the horizontal line bisecting that region, and subsequent display of the modified image.

The basic technique for accomplishing chart rotation is as follows. Without loss of generality, we assume the region to be rotated is rectangular in shape. Let image locations (A,B) and (C,D) denote the corner points of the rectangular region to be rotated, with A<C, 0≦A<W and 0≦C<W where W is the width of the image in pixels, and B<D, 0≦B<V and 0≦D<V where V is the height of the image in pixels. In rotating the chart image, any image coordinate that would normally be plotted at image location (X,Y), with A≦X≦C and B≦Y≦D, is instead plotted at (X, B+(D−Y)). The remaining image coordinates are plotted at their normal (un-rotated) locations.

Chart rotation is useful for exposing psychological bias on the part of the viewer of the image. Suppose the viewer has a “buy-side bias”, meaning an inclination to interpret chart patterns as bullish indicator(s). When evaluating a security whose price is declining, such a viewer will typically have difficulty spotting sell opportunities. Under chart rotation the price now appears as increasing, and (due to the buy-side bias) the viewer can typically see the buy opportunities, and thus that the un-rotated chart image offers corresponding sell opportunities.

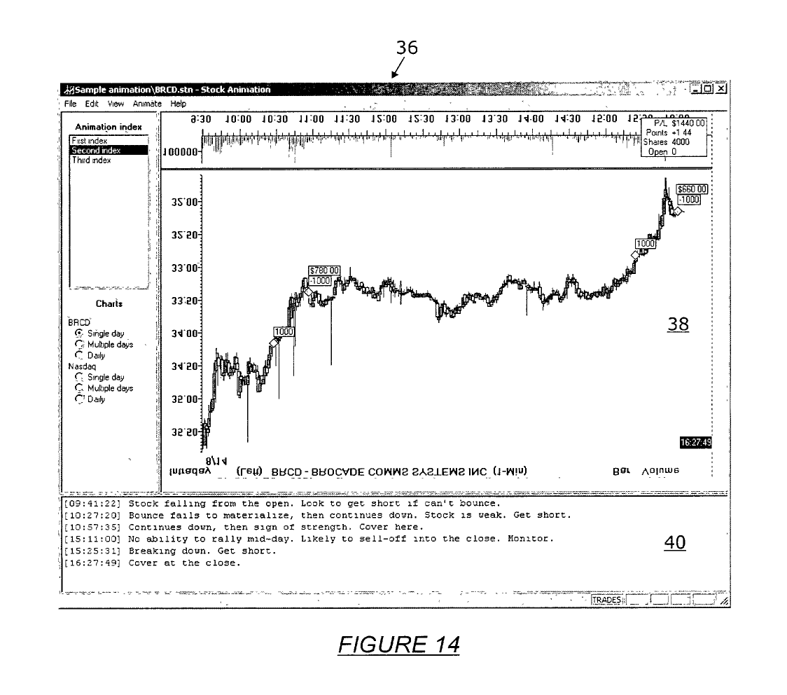

In one representative embodiment of the system (12 in FIG. 2), any chart image can be rotated; the entire chart image is rotated, using the approach outlined above. FIG. 14 shows the interface panel 36 for this representative embodiment after the user has issued the appropriate command, accessed from the menu bar 42, to rotate the chart image displayed in the graphics area 38. The “action” property of each trade event has been switched, i.e., “buy” trade events have become “sell” trade events, and vice versa.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of displaying price charts, comprising:
loading into a memory a set of stored chart images representing a set of price charts;
displaying a selected one of the stored chart images on a screen; and
mapping between a set of pixel positions on the selected stored chart image and a set of charted points on the corresponding price chart.

2. The method of claim 1, wherein the charted points have time values.

3. The method of claim 2, wherein mapping between pixel positions and charted points comprises determining a constant factor representing a time value associated with each of the pixel positions.

4. The method of claim 3, wherein determining the constant factor comprises selecting two distinct pixel positions on the selected stored chart image and determining a time value spanned by the two distinct pixel positions.

5. The method of claim 4, wherein determining the time value spanned by the two distinct pixel positions comprises determining a time value associated with each of the two distinct pixel positions.

6. The method of claim 4, wherein determining the time value spanned by the two distinct pixel positions comprises receiving the time value through a user interface.

7. The method of claim 4, wherein determining the time value spanned by the two distinct pixel positions comprises reading the time value from a file.

8. The method of claim 1, wherein the charted points have price values.

9. The method of claim 8, wherein mapping between pixel positions and charted points comprises determining a constant factor representing a price value associated with each pixel position.

10. The method of claim 9, wherein determining the constant factor comprises selecting two distinct pixel positions on the selected stored chart image and determining a price value spanned by the two distinct pixel positions.

11. The method of claim 10, wherein determining the price value spanned by the two distinct pixel positions comprises determining a price value associated with each of the two distinct pixel positions.

12. The method of claim 10, wherein determining the price value spanned by the two distinct pixel positions comprises receiving the price value through a user interface.

13. The method of claim 10, wherein determining the price value spanned by the two distinct pixel positions comprises reading the price value from a file.

14. The method of claim 2, further comprising specifying a timestamp and modifying the display of the selected stored chart image such that only a portion of the selected stored chart image indicated by the timestamp is visible on the screen.

15. The method of claim 14, wherein the timestamp is specified as a time value.

16. The method of claim 14, wherein the timestamp is specified as a pixel position.

17. The method of claim 14, wherein specifying the timestamp comprises receiving the timestamp through a user interface.

18. The method of claim 14, wherein specifying the timestamp comprises reading the timestamp from a file.

19. The method of claim 14, wherein modifying the display of the selected stored chart image comprises copying only the portion of the selected stored image indicated by the timestamp to the screen for display.

20. The method of claim 14, wherein modifying the display of the selected stored chart image comprises overlaying at least one image on the selected stored chart image such that only the portion of the selected stored image indicated by the timestamp is visible on the screen.

21. A computer-readable medium having computer-executable instructions for performing the method of claim 1.

22. A method of displaying price charts, comprising:
rendering a price chart image on a screen;
specifying a set of trade events, each trade event having a time value, a price value, and an action property; and
selectively displaying the trade events on the rendered price chart image;
wherein, for each displayed trade event, the rendering of the price chart image is modified such that a graphic notation is shown at a point on the price chart corresponding to the time and price values of the trade event.

23. The method of claim 22, wherein the graphic notation comprises an indication of the action property of the trade event.

24. The method of claim 22, further comprising specifying a quantity property for each trade event indicating a number of shares traded.

25. The method of claim 24, wherein the graphic notation further comprises an indication of the quantity property of the trade event.

26. The method of claim 22, wherein the time value of each trade event is bounded by the time values charted on the rendered price chart image, and the price value of each trade event is bounded by the price values charted on the rendered price chart image for the time value of the trade event.

27. The method of claim 22, wherein specifying the set of trade events comprises receiving a description of the trade events through a user interface.

28. The method of claim 22, wherein specifying the set of trade events comprises using a screen pointing device to indicate a pixel position on the rendered price chart image.

29. The method of claim 22, wherein specifying the set of trade events comprises reading a description of the trade events from a file.

30. A computer-readable medium having computer-executable instructions for performing the method of claim 22.

31. A method of displaying price charts, comprising:
specifying a timestamp sequence;
iteratively selecting individual timestamps from the timestamp sequence; and
for each selected timestamp, rendering a price chart image on a screen such that a set of charted points indicated by the selected timestamp is displayed.

32. The method of claim 31, wherein the timestamps are specified as time values.

33. The method of claim 31, wherein the timestamps are specified as pixel positions.

34. The method of claim 31, wherein specifying the timestamps comprises receiving a description of the timestamps through a user interface.

35. The method of claim 31, wherein specifying the timestamps comprises reading a description of the timestamps from a file.

36. The method of claim 31, wherein rendering the price chart image comprises loading into a memory a stored chart image and making visible on the screen a portion of the stored chart image indicated by the selected timestamp.

37. The method of claim 31, wherein the set of charted points are derived from a set of price data indicated by the selected timestamp.

38. A computer-readable medium having computer-executable instructions for performing the method of claim 31.

39. A method of displaying price charts, comprising:
rendering a price chart on a screen such that in response to input instructions a specified portion of the rendered price chart is rotated by a specified degree about a specified axis.

40. A computer-readable medium having computer-executable instructions for performing the method of claim 39.
